(19) United States
(12) Patent Application Publication
(10) Pub. No.: US 2013/0029308 A1
(43) Pub. Date: Jan. 31, 2013

(54) METHODS AND COMPUTER-PROGRAM PRODUCTS FOR TEACHING A TOPIC TO A USER

(71) Applicants: ARTHUR C. GRAESSER, MEMPHIS, TN (US); DIANE F. HALPERN, ALTDENA, CA (US); KEITH MILLIS, SHOREWOOD, IL (US)

(72) Inventors: ARTHUR C. GRAESSER, MEMPHIS, TN (US); DIANE F. HALPERN, ALTDENA, CA (US); KEITH MILLIS, SHOREWOOD, IL (US)

(21) Appl. No.: 13/648,796

(22) Filed: Oct. 10, 2012

Related U.S. Application Data
(63) Continuation of application No. 13/383,058, now abandoned.
(60) Provisional application No. 61/223,945, filed on Jul. 8, 2009.

(51) Int. Cl. G09B 3/00

(52) U.S. Cl. 434/327

(57) ABSTRACT

Aspects of the invention provide methods and computer-program products for teaching a topic to a user. One aspect of the invention provides a method for teaching a topic to a user. The method includes: administering one or more question to assess the user's knowledge of the topic; displaying a first interactive pedagogical agent and a second interactive pedagogical agent; and facilitating a trialog between the user, the first interactive pedagogical agent, and the second interactive pedagogical agent.

### CROSS REFERENCE TO RELATED APPLICATIONS

This application is a continuation of U.S. patent application Ser. No. 13/383,058, which is a national phase entry application under 35 U.S.C. §371 of International Application No. PCT/US2010/041387, filed Jul. 8, 2010, which claims priority to U.S. Provisional Patent Application Ser. No. 61/223,945, filed Jul. 8, 2009. The entire contents of each application is hereby incorporated by reference herein.

### BACKGROUND OF THE INVENTION

The importance to individuals and societies of having a solid foundation in scientific inquiry cannot be overestimated. The advancement of scientific knowledge depends on the application of the skills needed for scientific inquiry. Scientific inquiry is not only crucial for scientists and aspiring scientists, but also to the lay public who are exposed to causal claims made by scientists, companies, and individuals almost daily via the Internet, television, and print media. Millions of dollars are spent annually on products that are “packaged” as scientific, even though the “research” or evidence is highly suspect or absent. For example, millions of dollars are spent on homeopathic remedies that lack scientific evidence for their effectiveness. Scientific inquiry is important to the workplace, especially as jobs become increasingly technical, require specialized skills, and require domain-specific problem-solving, reasoning, and decision making. Ideally, everyone should know how to critically evaluate the products of science and evidence-based claims.

There are many reasons why students score low on science assessments. Students often have difficulty understanding and learning from their textbooks. This difficulty can partly be attributed to the finding that most students do not spontaneously apply appropriate reading strategies, such as paraphrasing, predicting and explaining the text, and do not accurately monitor their comprehension. Many students are passive readers with such poor comprehension calibration skills that they do not recognize when they do not understand the material.

A second reason is that most classroom experiences provide limited training on the process of students transferring their knowledge to new domains and situations. On the average, high school students take three years of science and two science areas. However, they only participate in laboratory experiences an average of one hour per week. There are few opportunities for advanced science courses; one-third of high schools do not offer any while another third offer only one (typically biology). According to one study, laboratory experiences are extremely varied. Some are dominated by a few gifted students. Many have the instructor and students follow a “cookbook” procedure that does not focus attention to underlying principles and concepts. Consequently, there is a notable lack of reflection and discussion among and between students and teachers. Most important to the current proposal is that much of the time in science courses is spent on learning didactic content, which is relevant to scientific literacy but not necessarily to scientific inquiry.

Exposure to scientific inquiry does not appear to be much greater in higher education. College and university students in introductory science courses are typically only exposed to a section or a chapter dedicated to scientific inquiry (methods) in their textbook. When scientific inquiry is covered by introductory science textbooks, the skills are depicted by only a few examples. For example, a student in a biology course might read about the steps in scientific inquiry from a section on the consequences of the pesticide dichloro-diphenyltrichloroethane (DDT), whereas a student in a psychology course might learn about scientific inquiry by testing whether music interferes with learning. Unfortunately, humans are notoriously poor in being able to transfer and use knowledge from one domain to understand another unless they are taught in ways that enhance transfer. Students typically store knowledge according to the way it was originally learned within a content area, but not according to cross-domain skills that are needed for analogical transfer. Transfer is increased when people are exposed to a number of examples taken from different domains and when instructed to verbalize the structural aspects of the problem, thereby making it explicit. In other words, transfer of skills and knowledge are best achieved when teachers deliberately teach for transfer, a situation that does not exist within most academic content areas.

Although various existing methods of teaching methods of teaching scientific inquiry yield learning gains, existing methods do have some notable limits. First, technology-enhanced learning environments require close cooperation between teachers, students, policy makers, and educational researchers. That is, a broad scale classroom culture needs to be implemented and maintained. Teachers need to be “on board” with the technology, content, and time-schedules. A mentor typically needs to be placed along side the teacher or professional development opportunities must be awarded to the teacher. In short, without meaningful incentives and genuine “buy-in” of the concept from the teachers, it is unclear how many science teachers in high school, college, and university settings will eventually change their curriculum and teaching styles to suit such programs. Second, scientific content is usually emphasized more explicitly than scientific inquiry skills, although it should be acknowledged that the methods vary along the content versus skill spectrum. Third, most of the advanced programs cited above have been constructed, implemented, and tested in grades K-12. There is a need to focus on learning environments that are tailored for college and university students, as well as the general public. Lastly, computers in high school science classrooms are relatively rare: in 2000, fewer than 10% of science lessons used computers.

Accordingly, there is a need for systems and method for teaching scientific inquiry in a game environment.

### SUMMARY OF THE INVENTION

Aspects of the invention provide methods and computer-program products for teaching a topic to a user.

One aspect of the invention provides a method for teaching a topic to a user. The method includes: administering one or more question to assess the user's knowledge of the topic; displaying a first interactive pedagogical agent and a second interactive pedagogical agent; and facilitating a trialog between the user, the first interactive pedagogical agent, and the second interactive pedagogical agent.

This aspect of the invention an have a variety of embodiments. In one embodiment, if the user has a low level of knowledge of the topic, the step of facilitating a trialog includes presenting a lesson from the first interactive pedagogical agent to the second interactive pedagogical agent while the user observes the lesson. In another embodiment, if the user has a medium level of knowledge of the topic, the step of facilitating a trialog includes presenting a lesson from the first interactive pedagogical agent to the user while the second interactive pedagogical agent observes the lesson. In still another embodiment, if the user has a high level of knowledge of the topic, the step of facilitating a trialog includes asking the user to present a lesson to the second interactive pedagogical agent while the first interactive pedagogical agent observes the lesson.

The first pedagogical agent can be a human. The first pedagogical agent can be a computer-implemented character. The second pedagogical agent can be a human. The second pedagogical agent can be a computer-implemented character. The method can be implemented in a game environment. The method can be a computer-implemented method.

Another aspect of the invention provides a computer program product including computer-usable medium having control logic stored therein for causing a computer to implement method for teaching a topic to a user. The control logic includes: first computer-readable program code means for administering one or more question to assess the user's knowledge of the topic; second computer-readable program code means for displaying a first interactive pedagogical agent and a second interactive pedagogical agent; and third computer-readable program code means for facilitating a trialog between the user, the first interactive pedagogical agent, and the second interactive pedagogical agent.

This aspect of the invention can have a variety of embodiments. In one embodiment, if the user has a low level of knowledge of the topic, the third computer-readable medium presents a lesson from the first interactive pedagogical agent to the second interactive pedagogical agent while the user observes the lesson. In another embodiment, if the user has a medium level of knowledge of the topic, the third computer-readable medium presents a lesson from the first interactive pedagogical agent to the user while the second interactive pedagogical agent observes the lesson. In still another embodiment, if the user has a high level of knowledge of the topic, the third computer-readable medium asks the user to present a lesson to the second interactive pedagogical agent while the first interactive pedagogical agent observes the lesson.

The first pedagogical agent can be a human. The first pedagogical agent can be a computer-implemented character. The second pedagogical agent can be a human. The second pedagogical agent can be a computer-implemented character. The method can be implemented in a game environment. The computer-usable medium can be non-transitory and tangible.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views and wherein:

FIG. 1 depicts a screen shot of a computer program according to one embodiment of the invention.

FIGS. 2A-2C provide a flow chart depicting the operation of a computer program according to one embodiment of the invention.

FIG. 3 depicts a method of teaching a topic according to one embodiment of the invention.

### DETAILED DESCRIPTION

Various aspects of the invention provide systems and methods for teaching various topics such as scientific inquiry in a game environment. In some embodiments, the systems and methods are implemented on one or more general purpose computers.

Embodiments of the invention can be implemented via the Internet and can be accessed from a variety of locations including from school or home. Students located in different geographical locations can become “learning partners” that progress through the modules at the same time and who share their thoughts as they learn. Because of the invention's broad and flexible accessibility, teachers can assign tutor sessions as homework across a semester or for stretches of time that do not encroach on class time. Although students can be expected to work on the assignmentss by themselves, embodiments of the invention include social aspects of peer tutoring and reciprocal teaching because students will interact with different interactive pedagogical agents, one of which can play the role of a fellow student. Therefore, the invention does not demand a particular classroom culture, and can be utilized by college and university professors who do not want to change their curriculum or take class time for an adjunct curriculum activity.

Embodiments of the invention focus explicitly on scientific inquiry, particularly on the process of evaluating and critiquing studies and experiments. The invention can also cover different areas of science, namely biology/life sciences, psychology, and chemistry. This will provide opportunities for investigating transfer across domains, both in the process of learning science inquiry and in assessments of transfer across science domains.

### Pedagogical Agents

Embodiments of the invention teach scientific inquiry via two animated pedagogical agents. One agent, called the Guide-Agent, guides the student through the tutor lessons and is an expert on scientific inquiry. The role of the Other-Agent can vary depending on the current state of the tutor (e.g., which scenario or problem is being presented). Exemplary roles for the Other-Agent include: a fellow student, a judge listening to an appeal, a neighbor discussing a type of plant food, or a scientist presenting her work. Users can interact with both agents by holding mixed-initiated dialogs in natural language that mimic real interactions between human tutors and students. The agents can give the students texts to read, pose diagnostic questions and situated problems to the user, give hints and feedback, encourage question-asking, answer questions posed by the user, and keep track of the user's progress.

Users can have the ability to search electronic copies of one or more texts. For example, in embodiments directed to teaching scientific inquiry, users can have access to texts such as Diane Halpern, “Thought & Knowledge: An Introduction to Critical Thinking” (2002) for information on scientific inquiry, research methods, inductive and deductive reasoning, arguments, decision making and fallacies. In addition, the invention can provide an electronic notebook so that users can take notes as they progress. Users can also earn points as they progress through the program, thereby motivating the users and providing a serious game-like feel.

Embodiments of the invention include two conceptually different modules: “Interactive Text” and “Active Application.”

In the Interactive Text module, users read about key concepts. For example, to learn about scientific inquiry, the user can read about the need for control in an experiment. The concepts can be introduced by the Guide-Agent, who will provide a context that will arouse the curiosity of the user. For example, to introduce the concept of operational definition, the Other-Agent might say, “My roommate and I got into an argument yesterday on who was more influential on hip hop: James Brown or Stevie Wonder,” to which the Guide-Agent might respond, “You know, you could have resolved the argument by using what scientists call an operational definition.” The text will then define and explain the importance of the concept as well as providing examples.

It is likely that the knowledge gained from reading the text alone will be somewhat shallow, just as reading a textbook usually results in shallow learning. Therefore, embodiments of the invention allow the user to engage in tasks that will engender deeper learning of the concepts. One such task is reciprocal teaching, where the student explains challenging concepts to the Other-Agent who will be a fellow student.

In the Active Application module, students will evaluate realistic examples of research in various contexts by applying what they learned in the Interactive Text module. An Active Application problem will use an example relevant to the introduction. For example, the user can be asked to identify and describe operational definitions of musical influence (e.g., the number of times an artist is sampled in music). In another example of an Active Application problem provided in the Appendix herein, the user is asked to evaluate a study, such as one that purports to show that students do not learn anything from their textbooks.

These two primary modes of instruction, Interactive Text and Active Application, can be presented via blended instruction so that students will learn about three to six concepts in the Interactive Text module before interacting with the Active Application module regarding those concepts. The concepts relevant to the Active Application problems can be cumulative so that any problem presented in Active Application could require concepts learned at any time previous in the instruction. After the user has completed all of the concepts in an Interactive Text module, the user can be given additional and more challenging Active Application problems in order to optimize the learning and transfer of those concepts.

Students can interact with the invention across several sessions, thereby contributing to durable learning.

Embodiments of the invention propose a focused, but novel approach to learning important aspects of scientific inquiry. In such embodiments, the user “learns by evaluating,” which is somewhat analogous to learning by design. Users learn about scientific inquiry by evaluating many realistic but (mostly) flawed studies. A guiding assumption is that by evaluating many examples of research, students will acquire knowledge of appropriate methods and designs that are needed to establish causal relations between variables and to recognize and understand the pitfalls and messiness of doing real science. Thus, users employ techniques that are at the heart of quality instruction in critical thinking. The “critical” aspect refers to “critique,” evaluation, or the formulation of judgments about the quality of thinking. By acquiring the skills needed to evaluate studies, students are expected to improve their learning of science content in courses, become better informed citizens, and perhaps even seek careers in science. This could decrease the minority gaps in science fields.

### Application of Learning Principles

Embodiments of the invention are conceptualized upon key learning principles that have been empirically supported by researchers in the learning and cognitive sciences. Users should acquire the skills necessary to evaluate causal claims in the context of studies and personal experiences, i.e., to maximize learning and transfer. In order to maximize learning, users will explain the problems they find with studies and causal claims. They will do so by holding dialogs with animated agents. These activities incorporate the principles of self-explanation, active learning, and dialog interactivity that shows learning increases with the number of dialog contributions. Users can teach an animated agent, thereby capitalizing on the benefits of reciprocal teaching where students and teachers take turns teaching. Agents can give immediate feedback to the student based on the learning principle of feedback. Additionally, students can constantly retrieve what they have learned during the Interactive Text module in order to evaluate problems, thereby incorporating testing and spacing effects. Finally, many of the problems will be written to maximize reflection. In order to maximize transfer, students can be exposed to materials that depict topics from different disciplines but which cover the same underlying inquiry principles, thereby incorporating the principle of variable encoding. According to the principle of authentic learning, because the materials will be similar to actual studies encountered in the media, users should be able to transfer the skills learned by interacting with embodiments of the invention to new situations.

### Components and Architecture

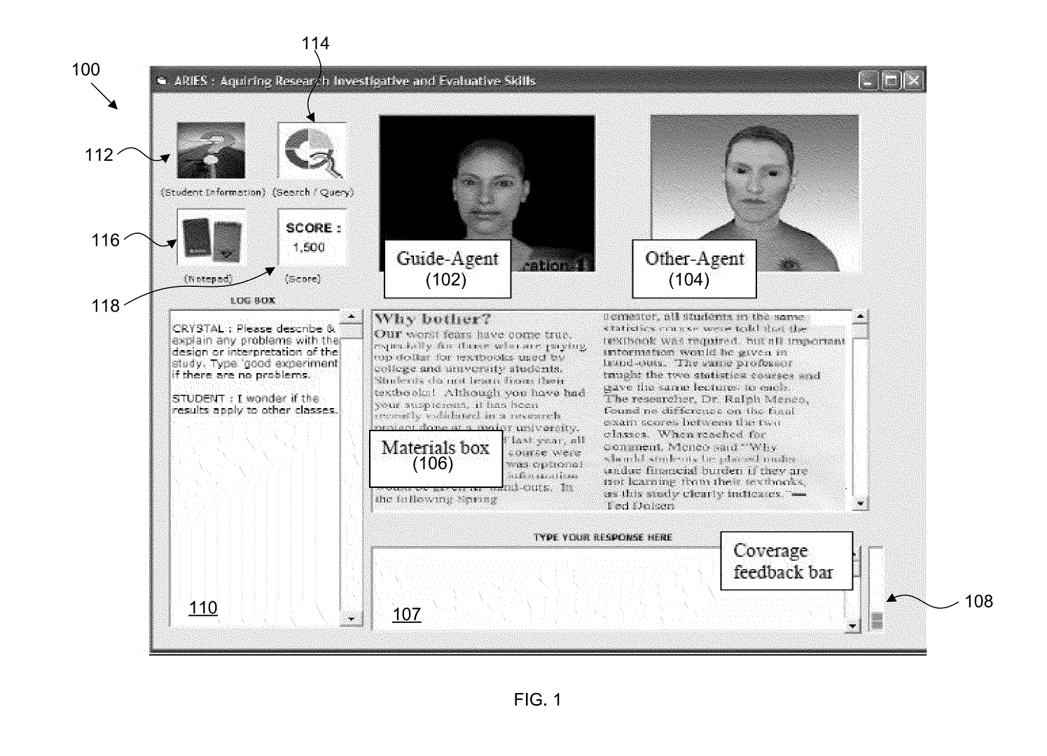

FIG. 1 shows a screen shot 100 of a computer program according to one embodiment of the invention. The window includes two pedagogical agents 102, 104, a materials box 106 in which text, questions, and other materials appear, a response frame 107 in which students type in their responses, a coverage feedback bar 108, and a log box 110 which saves the verbal responses from the agents and students for the current problem. Optionally, the log box 110 can be used to present responses from other geographically distant students that the user is interacting with. Besides these general areas, the user has the option to access information by clicking on one or more icons.

Pressing the Student Information icon 112 will provide global feedback on the user's performance in the session and on the amount of remaining material. This information can be depicted pictorially as a star map. In such an example, each concept can be initially be depicted as an unlabeled grey circle against a black background. The circles can be arranged in line with the constellation Aries. When a concept is introduced in Interactive Text, the appropriate circle will become labeled. When a user answers questions correctly about the concept in Active Application problems, its circle will become white. When the user displays deep learning of the concept (e.g., correctly applying it to two Active Application problems without any hints or prompts), the circle will become a star and a summary of that concept will appear in a ‘tool tip’ box when the curser is passed over it. The number of remaining grey circles will indicate the number of to-be-learned concepts (roughly correlated with the number of remaining problems) and the number of white and starred concepts will indicate how far and well the student is progressing and doing. This embodiment of presenting global feedback will motivate users, who can compare “star maps” among themselves. In addition to global feedback, a coverage feedback bar can indicate how much of a current Active Application problem is covered.

The Search/Query icon 114 enables the user to access an electronic copy of one or more texts relevant subject to be taught. Users can access this feature at any time, except when a test is presented.

The Notepad icon 116 provides access to an electronic notepad for typing notes. The contents of the notepad can be saved at the end of each session so that it will maintain a cumulative record of notes and will be available for future sessions. The notepad can also be automatically updated by the tutor when a student's learning of a concept reaches a defined threshold. At that time, the tutor can append a summary of that concept to the contents of the notepad. For example, once the student has understood the concept of “hypothesis,” the notepad can be appended with “Hypothesis—an assertion based on a theory that specifies a testable relation between two or more variables, and can be falsified by an experiment.”

The Score icon 118 displays the number of points earned by the user for the current problem. This differs from the feedback coverage bar 108, which depicts how close the user is to completing a problem.

### Exemplary Process and Architecture

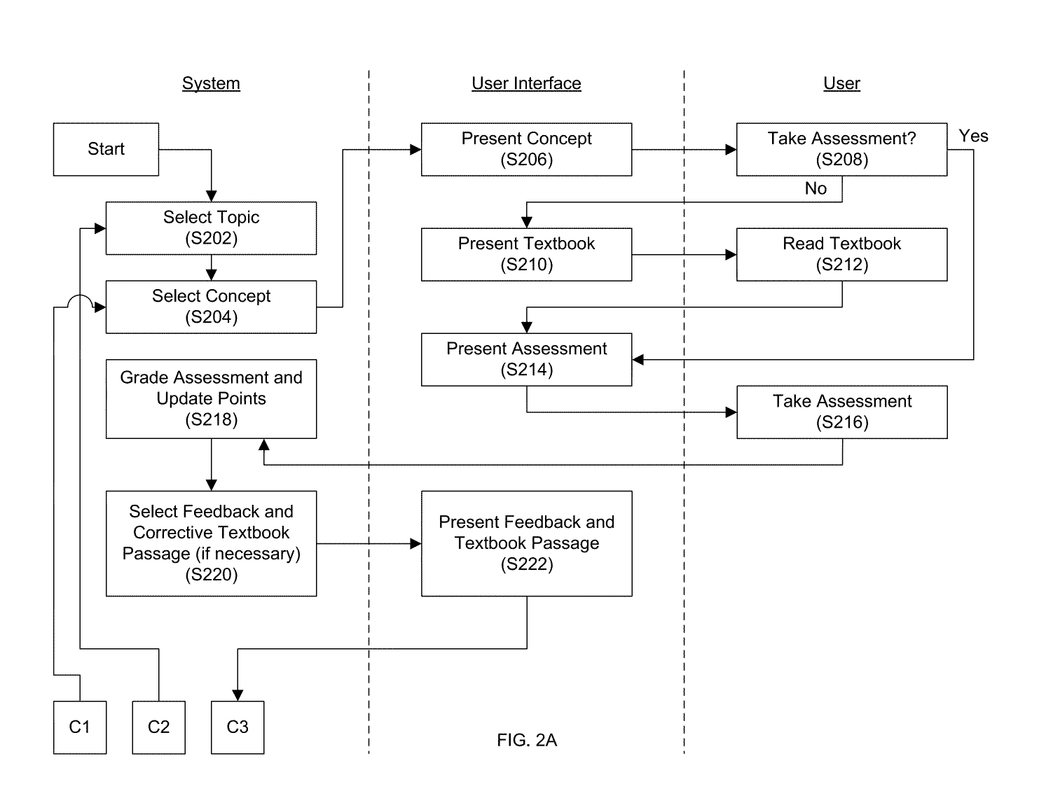

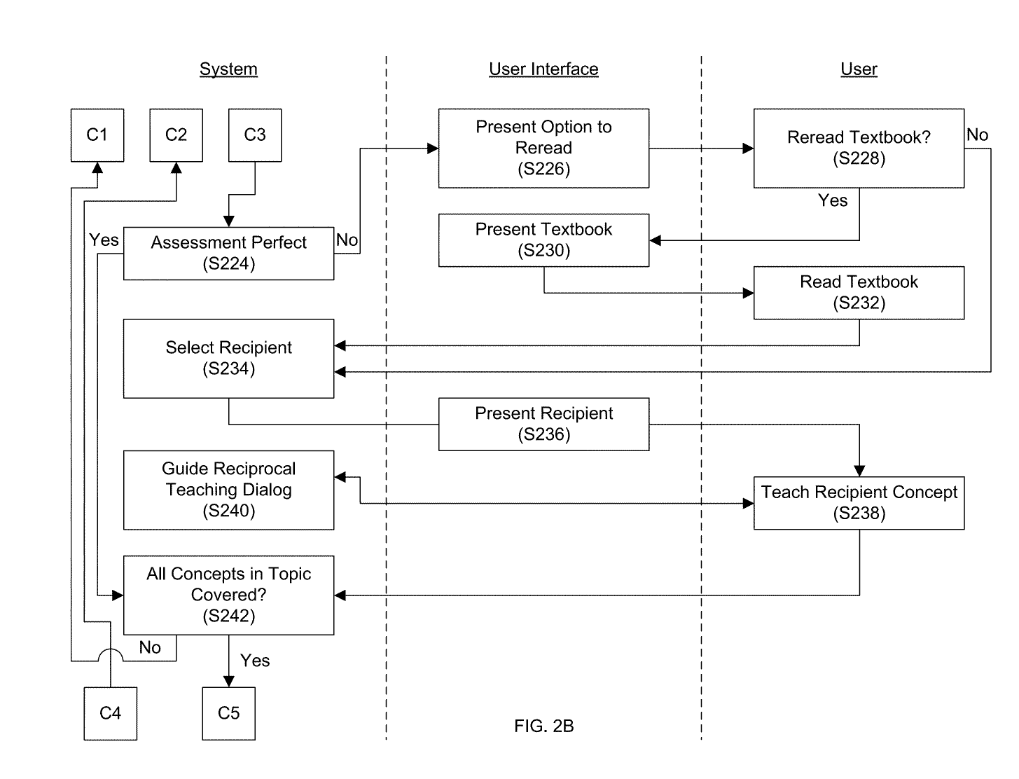

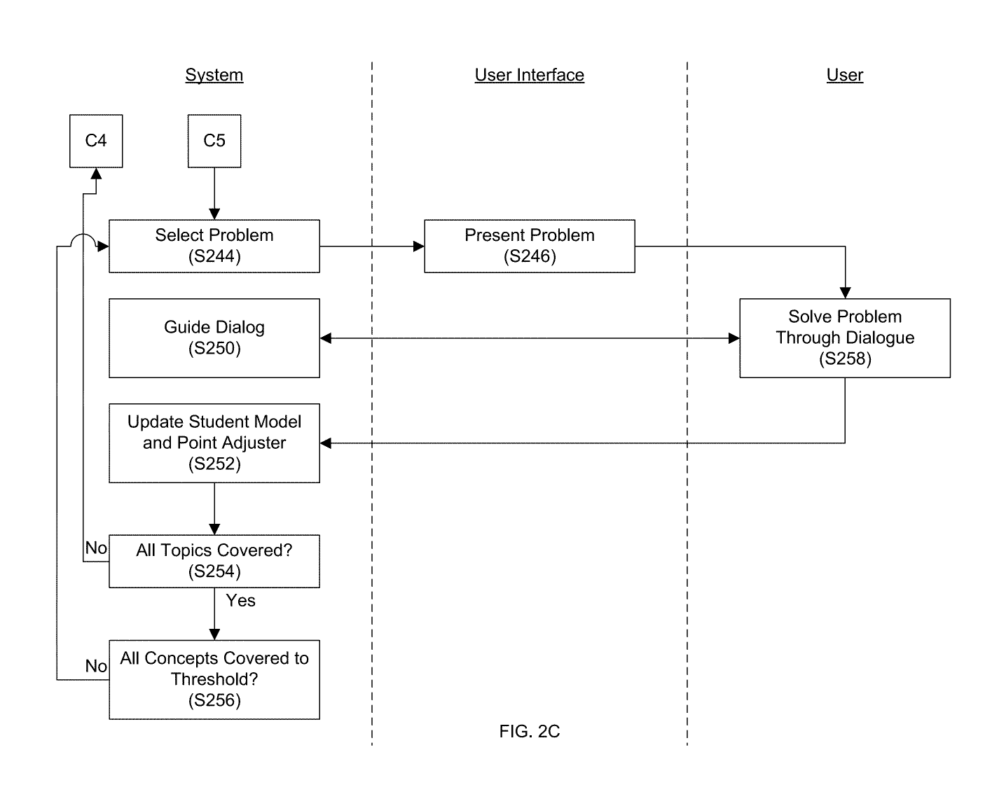

The process model and architecture of a computer program according to one embodiment of the invention is depicted in FIG. 2. The back-end system (depicted in the shaded far left column) handles the logic and calculation, the user interface (depicted in the shaded middle column) presents what is shown on a display (e.g., a liquid crystal display), and the user (depicted in the shaded right column) interacts with the user interface. For clarity of presentation, the steps involved in Interactive Text (depicted in the top half of the flow chart) are discussed separately from the steps involved in Active Application (depicted in the bottom half of the flow chart), but the users will experience them in a blended fashion. The Other-Agent during Interactive Text will often be a fellow student, whereas during Active Application, the Other-Agent will be variable and relevant to the current problem.

### Interactive Text

In steps S202 and S204, a topic and concept are selected, respectively. All concepts covered by a game environment are grouped into topics by thematic coherence. For example, one topic can contain concepts regarding “hypotheses” such as the definition of hypothesis, testability, and falsification. The topics can be ordered according to the scientific process (In such an embodiment, the hypothesis topic can be near the beginning and a topic involving the interpretation of results (e.g., tentative conclusions, alternative explanations) can occur near the end. Steps S202 and S204 select concepts from a topic for the student to work on. The number of concepts in a topic can typically range from three to six.

In step S206, concepts are presented to the user. Generally speaking, only one concept in a topic will be presented at a time through Interactive Text. The Interactive Text module can cycle through all concepts in a topic until coverage is complete. The order of topics and of the embedded concepts can be determined a priori.

After a concept is selected, in step S208 the Guide-Agent can ask whether the user wishes to take a “challenge” regarding the concept. The challenge can be to answer questions about the concept and can be presented in step S214. The initial assessment can be introduced in step S206 by the Guide-Agent by saying “OK, I want to talk about concept X. Type ‘yes’ if you want to take the challenge, or ‘no’ if you want to go straight to reading the text.” (This will follow the encouraging preamble providing context for the concept.)

There are three reasons for having a voluntary initial assessment. First, having some choice in the task increases motivation for that task. Second, the initial assessment component will allow the more knowledgeable users to bypass intensive reading about a subject, hopefully preventing boredom and frustration that they might experience if they were forced to read texts regarding concepts they already know well. Third, the challenge should expose the users' illusion of competence, thereby making students more metacognitively aware of gaps in their knowledge regarding that concept, especially if users answer a test item incorrectly.

The Other-Agent 104 (e.g., a fellow student) can also answer the initial assessment questions. This agent (he or she) can look down at the materials 106 box as the user reads the text. The Other-Agent 104 can optionally comment on the readings, perhaps saying something funny or motivational, or perhaps clarifying known misconceptions or giving a summary of it. In either case, the Other-Agent's answer will appear in the log box after the human student supplies an answer. The correctness of the Other-Agent's answer can be determined by a student-goodness parameter. For example, a “knowledgeable” Other-Agent 104 may answer approximately 90% of the of the questions correctly, a “less knowledgeable” Other-Agent 104 may answer approximately 30% to 50% of the questions correct, and a “peer” Other-Agent 104 may give the same answer as the human student 90% of the time. The “peer” Other-Agent 104 might also be the same as the “knowledgeable” or “less knowledgeable” Other-Agents 104 depending on the performance of the human learner. The “less knowledgeable” Other-Agent 104 may be preferred in some embodiments so that reciprocal teaching happens more often than not.

For each concept, associated diagnostic questions (e.g., three or more associated diagnostic questions) can be stored in a problem database. The questions tap the user's knowledge of the concept definition, its implementation in examples, and its role in scientific inquiry, respectively. The format of the questions can be multiple-choice and true-false. The questions can be designed to be challenging, so that only the more advanced students can answer all three questions correctly without reading the text that teaches the concept. Learning materials can be pre-tested to ensure an appropriate difficulty level. Example questions for the concept “operational definition” and associated text are presented in the Appendix.

After the user answers a question by typing in their answer (as well as receiving a response from the Other-Agent 104), the Guide-Agent 102 can give immediate feedback (“right” or “wrong”). Questions can be scored and points can be awarded to students based on the number of questions answered correctly in step S218. In some embodiments, each question can be worth 1,000 points.

For users who elect in step S208 to take the assessment before reading the text, the system can in step S220 select text associated with the question(s) that were incorrectly answered in the assessment, if there were any, and pass the text to the materials box 106 in step S222. Therefore, a user who completed the initial assessment will only read text that fills knowledge gaps of the student or clarifies a misconception. If the user answered all three questions correctly, then the text can read, “Congratulations!” or a motivational or funny comment from the Other-Agent 104. Care can be taken to ensure that the texts are coherent even when one or two of the three text parts (i.e., definition, examples, importance) are missing. Users who do not wish to take the initial assessment in step S208 can be presented the entire text in step S210 before being given the assessment in step S216.

If a user answers a predetermined number of questions from the ‘challenge’ assessment incorrectly in step S216, the user can engage in reciprocal teaching. In reciprocal teaching, the tutor and user take turns leading the dialogue on the instructional material. A version of reciprocal teaching can be implemented in which the user explains and/or answers questions posed by one of the two agents, but will be guided by hints and prompts by the Guide-Agent 102 when necessary. When a user working with ARIES encounters difficulty in producing the correct answers, the Guide-Agent 102 can offer similar suggestions (e.g., to reread the text or search the online text).

Before the student engages in reciprocal teaching, embodiments of the system can offer the student the option to reread the text in steps S226, S228, S230, and/or S232 in order to alleviate test anxiety and provide another opportunity for deep learning. In steps S234 and S236, the recipient of the reciprocal teaching (i.e., Guide-Agent 102 or Other-Agent 104) is identified. If the Other-Agent 104 answered at least two questions incorrectly, which would occur by chance approximately 40% of the time for the “less knowledgeable” Other-Agent 104, then the user will explain the concept to the Other-Agent 104; otherwise, the user will explain the concept to the Guide-Agent 102. In the former case, the Guide-Agent 102 may say something like, “Why don't you tell Jill (Other-Agent 104) what a hypothesis is and why it is important?” and Jill will echo the request by saying, “Yeah, I don't get it.” In the latter case, the Guide-Agent 104 can say, “Why don't you tell me what a hypothesis is and explain why it is important?”

Regardless of whom the user teaches (e.g., the Guide-Agent 102 or Other-Agent 104), the Guide-Agent 102 can provide hints and prompts to the student when needed (step S238). The primary reason for having the two different recipients of reciprocal teaching is that reciprocal teaching often has the more knowledgeable student teach the less knowledgeable student. Having the user explain a concept to the Other-Agent 104 when the fellow student missed the majority of the questions will tend to match this situation. However, it is also true in reciprocal teaching that the less knowledgeable teach the more knowledgeable. Having the user teach the Guide-Agent 102 matches this situation. In some embodiments, the user can choose which agent he or she teaches.

Reciprocal teaching can be achieved by using an AutoTutor component that facilitates a dynamic conversation with the learner in a semi-structured fashion that follows a curriculum script, in this case a script to guide the reciprocal teaching. Curriculum scripts contain (a) the main problem (e.g., a description of a faulty experiment), (b) expectations, which are anticipated good sentence-length answers that AutoTutor tries to extract from the user during the dialog (e.g., what is wrong with the experiment), and (c) hints and prompts for specific words from each expectation that could be spoken by either animated agent (e.g., “Think about what correlation means” or “Correlation does not mean what?”), and (d) a summary of each expectation which could be presented by an agent (e.g., “A significant correlation means that . . . ”). An example curriculum script and a resulting dialog is shown in the Appendix. AutoTutor is further discussed herein.

### Active Application

Once all of the concepts in a topic are covered, the user will engage in an Active Application relevant to that topic (step S242). The first computational step is to select the problem (step S244). In Active Application problems, the user will participate in a dialog with the Guide-Agent 102 or the Other-Agent 104 regarding the validity of a causal claim or empirically-based study. The topics can, in some embodiments, be based on material from Biology and Life Sciences, Chemistry, Psychology, and Sociology. As stated above, Active Application problems can be executed via the AutoTutor module. Therefore, for each problem, there will be a set of expectations (assertions or questions depending on the problem type) that one of the agents tries to elicit from the student. Examples of Active Application problems are presented in the Appendix.

When the user is still working within the Interactive Text module, problem selection can be associated with the particular topic of concepts that the student is currently working on. That is, the order of the Active Application problems can be determined by the Interactive Text component. Once the student completes all concepts in the Interactive Text component, problem selection can be based upon a quantitative assessment of the user's understanding of those concepts in the context of real world applications. Informally speaking, the program will tend to present problems in Active Application that contain concepts that the student has not yet mastered.

Problem selection is based upon a match between a user model and a problem database. The user model is a database that is updated as the user interacts with the Active Application problems. It contains a record of the problems that the user had been exposed to thus far, the particular concepts the problem taps, and the extent to which relevant concepts were successfully applied by the student in the learning history. The problem database is a permanent database that indexes the concepts relevant to problems and to specific expectations in their associated curriculum script.

There are four different types of problems in the current embodiments of the invention. The first type is called “Interactive Text Problems” because these occur as the student is progressing through the Interactive Text section. The Interactive Text Problems are presented at the end of each topic and are relevant to the concepts in that topic. These problems are shorter and less difficult than the other Active Application problem types. They typically depict a faulty example of one of the concepts in the topic. For example, in the Appendix, the Interactive Text Problem conveys a misconception of the concept “hypothesis.” It is important to note that not all Active Application problems will contain a flaw. It is important for users to identify intact problems as well as faulty problems. In some embodiments, roughly one-fourth of the Interactive Text Problems (and the Evaluation and Ask Problems described below) will not contain a flaw.

In “Evaluation Problems,” the Other-Agent 104 can describe or present a summary of a to-be evaluated study in the materials box, and the Guide-Agent 102 will ask the user to evaluate the study. The Guide-Agent 102 can interact with the user, trying to get him or her to articulate the expectations using hints and prompts. The Other-Agent 104 is used in these problems to situate the problem in a believable context and to react to the student's final assessment. For example, consider the second problem in the Appendix. In this problem, the Other-Agent 104 “Donatella” believes the claim “students do not learn from their textbooks” based on a magazine article presented in the materials box. The Guide-Agent 102 then asks the user to evaluate the study. The Guide-Agent 104 can provide hints and prompts to prod the user to articulate the expectations. Once the user has progressed through all expectations, a summary is given. If all expectations are covered by the user, the Other-Agent 104 (Donatella in this case) will present the final summary; otherwise it will be given by the Guide-Agent 102. A biology example is given in the Appendix.

In “Ask Problems,” the student is given a role, a goal, and a yes-no decision to make, based upon the student's evaluation of a study or relevant document presented in the materials box 106. In Ask Problems, the presented material will not be sufficient to evaluate the study. Instead, the student must ask the Other-Agent 104 questions that will reveal critical information about the study and provide clues for a correct yes-no decision. The Other-Agents 104 can be someone who can answer most questions put to him or her. In the example in the Appendix, the user assumes the role of a retirement home manager who is considering whether to buy a new type of water that an advertisement claims reduces arthritis. The user must ask the Other-Agent 104 (Dr. Johnson) about the study in order to make an informed decision.

There are two types of questions associated with Ask Problems: diagnostic and nondiagnostic. Diagnostic questions uncover information necessary for the student to make the correct decision. That is, they uncover a problem with the study's design, implementation, or how it was interpreted. In the example provided in the Appendix, the diagnostic questions reveal that there was no control group. Nondiagnostic questions are those that students might ask but that do not cover any problematic issues. In some embodiments, one half of the Ask Problems will have some type of flaw and the other half will not. Of course, for problems without any flaws, there will be no diagnostic questions

In “Reflection Problems,” the user will engage in an activity that should promote deep thinking and reflection. For example, the user might be given a description of a study and instructed to type three questions for the author. Alternatively, the user might be instructed to think of a hypothesis that contains the concept “chocolate.” In another example, the user might be instructed to think of how an ‘invalid measure’ might affect them personally. For these questions, the system may not use AutoTutor to guide expected responses because the responses in these cases will most likely be highly unconstrained and unique. Nevertheless, after the student enters his or her response, the Other-Agent 104 can offer a response so that the student can at least compare answers (e.g., Other-Agent: “The answer I came up with was that eating chocolate increases blood sugar”). The content of the Other-Agent's response, as well as the resulting Guide-Agent's response (e.g., “These are interesting. Eating chocolate increases blood sugar is good because it is an assertion.”) can be written to target common misconceptions.

There are three reasons for including problems that explicitly ask the student to ask questions. One is that they will encourage question-asking, dialogue moves which students have a great difficulty generating, but which promote comprehension when modeled and scaffolded. The second is that the question-asking task in this context requires deep reasoning through the problem space. Third, summaries are provided in most real-world encounters with studies and empirically-based claims, whereas details are revealed through question asking. This also increases students' awareness that critical information is often not provided. Therefore, these questions should help users prepare for future learning, a critical goal of educators. As a default embodiments of the invention will pick the type of Active Application problem by selecting those problems that manifest likely knowledge deficits of the learner. This is the normal approach to student modeling in intelligent tutoring systems and advanced learning environments. However, in some embodiments, the student may choose the type of problem in an effort to enhance motivation by putting them in control.

### AutoTutor

AutoTutor is a computer tutor that helps students learn about subject matters in science and technology by holding a conversation in natural language. AutoTutor is described at www.autotutor.org and in publications such as A. C. Graesser et al., “AutoTutor: An intelligent tutoring system with mixed-initiative dialogue,” 48 IEEE Trans. in Ed. 612-18 (2005); and A. C. Graesser et al., “Scaffolding deep comprehension strategies through Point&Query, AutoTutor, and iSTART,” 40 Educational Psychologist 225-34 (2005). AutoTutor simulates the dialogue moves and conversational patterns of human tutors, which were extensively analyzed in previous projects funded by Office of Naval Research and are described in publications such as A. C. Graesser et al., “Collaborative dialogue patterns in naturalistic one-to-one tutoring,” 9 Applied Cognitive Psychology 1-28 (1995).

AutoTutor's dialogues are organized around difficult questions that require reasoning and explanations. The primary method of scaffolding good student answers is through expectation and misconception tailored dialogue. Both AutoTutor and human tutors typically have a list of anticipated good answers (called “expectations,” e.g., force equals mass times acceleration) and a list of anticipated misconceptions associated with each main question. AutoTutor guides the student in articulating the expectations through a number of dialogue moves (e.g., pumps, hints, and prompts) for specific information. As the learner expresses information over many turns, the list of expectations is eventually covered and the main question is scored as answered. Another conversation goal is to correct the misconceptions that are manifested in the student's talk. When the learner articulates a misconception, AutoTutor acknowledges the error and corrects it. Yet another conversational goal is to be adaptive to what the student says. AutoTutor adaptively responds to the user by giving short feedback on the quality of student contributions (positive, negative or neutral) and by answering the user's questions. The answers to the questions can be retrieved from glossaries or from paragraphs in textbooks via intelligent information retrieval and computational linguistics.

AutoTutor is well suited to implement reciprocal teaching because units of dialog (the problem, hints and prompts, the summary) are modularized in the curriculum scripts that AutoTutor uses and therefore could be given by different agents. AutoTutor includes a dialogue management facility that allows the design of alternative conversation patterns in a short amount of time. The dialogue facilities can be designed to mimic realistic teacher-student exchanges. For example, if the human learner is teaching the Other-Agent 104, then the Other-Agent 104 can give hints and prompts (selected from either a small set or a large set of options in the curriculum scripts) that would be from a student's perspective. The Other-Agent 104 might say, “OK, wasn't there something else about hypotheses other than being testable?” Another strategy for implementing reciprocal teaching would be to have the Guide-Agent 102 give hints and prompts to the human learner for what to say to the Other-Agent 104. For example, the Guide-Agent 104 might say, “Come on, tell him about the idea of falsification.” If the human learner's responses match an expectation, then the Other-Agent 104 can respond with the summary for that expectation. For example, the Other-Agent 104 might say, “Oh, I get it now. Hypotheses are . . . . ” This will match the real-life situation of successful teaching, namely when the student can correctly summarize an idea and therefore give feedback to the teacher that they have indeed learned.

Embodiments of the invention utilize a user model to pick the next problem. The user model is an updateable database that records which Active Application problems the user has received, and the coverage of the expectations. An expectation can be covered (or completed) by the user in three ways. The first is when the user types in his or her initial answer. The second is when the user shows good understanding after the AutoTutor module gives a hint. The third is when a prompt elicits the correct answer. The purpose of the user model is to keep track of the user's learning so that the system can determine whether an expectation has been understood to threshold. If so, that expectation can be dropped from the algorithm that the problem selection uses in step S244 to intelligently choose the next problem. If a threshold is not reached, then the expectation is retained in the algorithm for problem selection. An expectation can considered to have reached a threshold when it has been met by the student's initial response in at least two Active Application problems.

The points awarded for dialogs held between an agent and the user in an AutoTutor problem in either Reciprocal Teaching (step S240) or in Active Application (step S250) can be based on the completion of the expectations (step S232). If an expectation is completed by the user's initial input, then the user can be awarded points (e.g., 2000 points); if completed only when a hint is given, the user can be awarded less points (e.g., 1500 points); and if only completed by a prompt, the user can be awarded still fewer points (e.g., 500 points). The system can cycle through Interactive Text and Active Application problems until all topics are covered in Interactive Text (step S256). As mentioned above, the system can continue to present Active Application problems to the student until the student has reached a determined level of competence of the concepts (step S254) or when there are no more Active Application problems left.

### Adaptation of AutoTutor

To develop AutoTutor for a new topic requires only four components, all of which address the subject matter knowledge: (1) a corpus of texts and articles in electronic form, (2) a glossary of terms in electronic form, (3) a Latent Semantic Analysis space derived from the corpus of texts, and (4) a curriculum script with case-based scenarios (i.e., example problems, main questions). A curriculum script contains the content associated with the set of scenarios, problems, or main questions. The scenarios, problems, and main questions can be accompanied by pictures, diagrams, videos, and other media. For each scenario, there is (a) the ideal answer, (b) a set of expectations, (c) families of potential hints, correct hint responses, prompts, correct prompt responses, and assertions associated with each expectation, (d) a set of misconceptions and corrections for each misconception, (e) a set of key words and functional synonyms, and (f) a summary.

Subject matter experts can create the content of the curriculum script with the “AutoTutor Script Authoring Tool” described in S. Susarla et al., “Development & evaluation of a lesson authoring tool for AutoTutor,” in AIED2003 Supplemental Proceedings 378-87 (V. Aleven et al. eds. 2003). Whereas it takes years to develop an intelligent tutoring system, content development in the AutoTutor system is measured in weeks or months. The AutoTutor software architecture developed at the Institute for Intelligent Systems at the University of Memphis also allows easy integration of new sensing devices and of different pedagogical strategies.

The nature of AutoTutor's dialogue patterns and conversational style can be modified in its dialogue planning architecture as described in A. C. Graesser et al., “AutoTutor: An intelligent tutoring system with mixed-initiative dialogue,” 48 IEEE Trans. in Ed. 612-18 (2005).

### The Effectiveness of AutoTutor

The learning gains of AutoTutor have been evaluated in 15 experiments conducted during the last eight years. AutoTutor improves learning at deep levels of comprehension (e.g., causality, interaction of components in systems). The effect sizes (in standard deviation units or sigmas) vary between 0.20 and 2.30 (mean of 0.80), depending on the subject matter, the test, and the comparison condition (e.g., pretests or reading a textbook for an equivalent amount of time). These effect sizes are substantially larger than obtained in most other types of research. The AutoTutor system is most effective when there is a large gap between the learner's prior knowledge and the ideal answers of stored in the AutoTutor system.

### Methods of Teaching a Topic

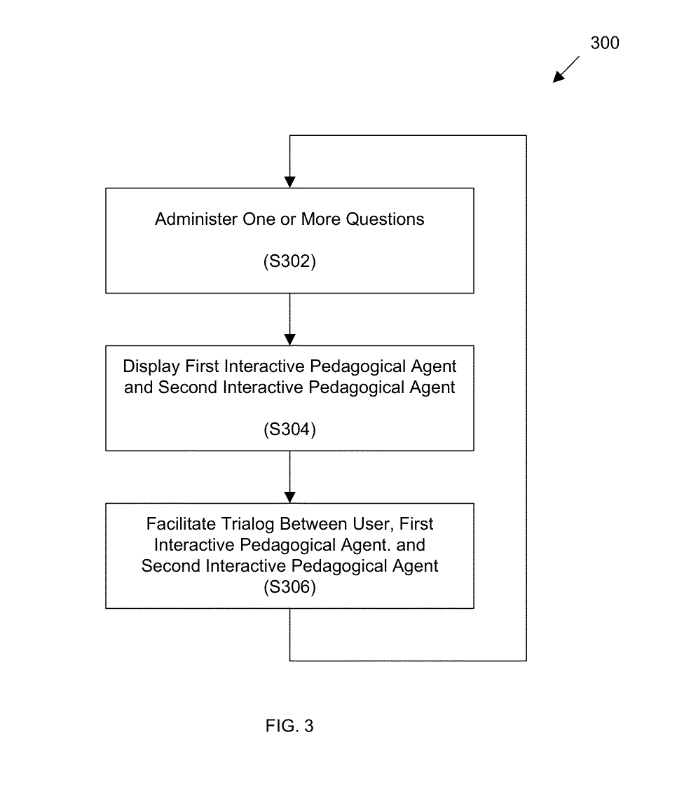

Referring now to FIG. 3, a method 300 of teaching a topic to a user is provided. The method can be implemented in a game environment as discussed herein. The method can be implemented on a computer as discussed herein. For example, a user may utilize a computer having one or more input means such a keyboard, a mouse, a trackball, a touchscreen, and the like to interact with a computer program executing on a local or remote computer. Such computer can include one or more output means such as a monitor, speakers, a printer, and the like.

In step S302, one or more questions are administered to assess the user's knowledge of the topic. These questions can of the type described herein.

In step S304, a first interactive pedagogical agent and a second pedagogical agent are displayed. The pedagogical agents can be images and/or video of actual human beings or can be fictional computer-implemented characters.

In step S306, a trialog is facilitated between the user, the first interactive pedagogical agent, and the second interactive pedagogical agent. A trialog is a conversation between two entities with a third entity observing the conversation and optionally providing comments, insights, questions, and other feedback. For example, if the user has a low level of knowledge of a topic, the trialog can be a lesson from the first interactive pedagogical agent to the second interactive pedagogical agent observed by the user. In another example, if the user has a medium level of knowledge of the topic, the trialog can be a lesson from the first interactive pedagogical agent to the user while the second interactive pedagogical agent observes the lesson. In still another example, if the user has a high level of knowledge of the topic, the trialog can include asking the user to present a lesson to the second interactive pedagogical agent while the first interactive pedagogical agent observe the lesson.

### INCORPORATION BY REFERENCE

All patents, published patent applications, and other references disclosed herein are hereby expressly incorporated by reference in their entireties by reference.

### EQUIVALENTS

The functions of several elements may, in alternative embodiments, be carried out by fewer elements, or a single element. Similarly, in some embodiments, any functional element may perform fewer, or different, operations than those described with respect to the illustrated embodiment. Also, functional elements (e.g., modules, databases, computers, clients, servers and the like) shown as distinct for purposes of illustration may be incorporated within other functional elements, separated in different hardware or distributed in a particular implementation.

While certain embodiments according to the invention have been described, the invention is not limited to just the described embodiments. Various changes and/or modifications can be made to any of the described embodiments without departing from the spirit or scope of the invention. Also, various combinations of elements, steps, features, and/or aspects of the described embodiments are possible and contemplated even if such combinations are not expressly identified herein.

### APPENDIX

### Sample Text and Challenge Questions for Interactive Text (Placed in the Materials Box)

An operational definition tells us how to recognize and measure the concepts that the researcher wants to understand.

Suppose you are sitting around your kitchen table (or where ever it is that you eat and talk with friends) and the conversation turns to the English test you are taking next week. One friend, Procrastinella, claims that she plans to study the night before the exam. She never studies until the night before the exam, not (as some might think) because she is lazy or procrastinates, but because she is certain that she learns best this way. Your other friend, Constantino, does not think that cramming the night before an exam could ever be the best way to learn. He took a class about how people learn, and he learned that the best way to study is to space out study sessions.

You think about both points of view and decide to perform an experiment. After all, how else can you decide between these two different beliefs about the best way to study? But, how do you get started? You have never conducted an actual experiment before. The first step is to identify the variables that are important for finding out whether Procrastinella or Constantino is correct. The variables—concepts that will be changing or varied during the research—need to be identified. The question you want to answer is whether it is better to do all of your studying the night before an exam, commonly known as cramming, or is it better to do your studying spaced over time, commonly known as spaced studying or spaced practice.

You decide to ask one group of friends to cram for the next exam, telling them to study only the night before the exam. You need to find another group of friends to space out their studying. You tell them to spread their studying out over the five days before the next exam. To be sure that it is the span of time that is causing an effect—in this case getting better grades on the exam—you would need to tell each group how long to study. Both groups could be told to spend 2½ hours studying—either all at once the night before the exam or spread out with a half hour a night for the five nights just before the next exam. These are very careful explanations of how to study for each of the two conditions—spaced and cramming.

But, how will you know which way of studying is better? You need to define how you will decide which of these methods is the “best way to study.” You need to decide what you are measuring as the outcome. In this example, the outcome could be getting a high grade on the next exam. You decide to find the average grade for the group that crammed and compare it to the average grade for the group that spaced out its studying. This is a clear-cut way of deciding which way of studying leads to the better results. Psychologists call a clear statement about how to measure a concept an “operational definition.” With operational definitions, anyone can measure the same outcome and arrive at the same conclusions. In this example, there are operational definitions for “cramming,” “spaced studying,” and the final exam scores for each group that will be used to decide which method of studying had the best effect on learning.

Let's try another example. Suppose you are thinking about finding an after school job, but your mother is concerned that you will just spend all the money you earn on “foolish stuff.”

Some nerve she has thinking you would spend your money to buy foolish stuff. You would only buy cool stuff like that new skateboard you saw in the store downtown. Your mother's response is so-o-o typical. She says, “See I told you so. A skateboard is foolish because you already have one.” “Harrumph! There is nothing ‘foolish’ about a new skateboard,” you retort. Can you understand that in this scenario you and your mother are arguing about the operational definition of “foolish stuff?” Her definition includes a new skateboard because you already have one. Your definition does not include a new skateboard, which you believe is a very sensible purchase because you will use it for many years to get around the neighborhood. If you both agreed upon an operational definition for “foolish stuff,” you would not be having this disagreement. Too often people disagree about many topics because they are not using the same operational definition.

Let's try out your understanding of operational definitions with some questions. (Italics denote the correct answers herein.)

Which of the following statements is a definition of “operational definition?”
A. An operational definition is a statement about the way that variables change during an experiment.
B. An operational definition is a clear statement about how to recognize and measure a variable.
C. An operational definition tells us how to operate on important variables in a controlled experiment.
D. An operational definition provides a clear statement that defines the questions that researchers want to answer in their experiment.

Which of the following statements is an example of an operational definition?
A. To be considered a success, you need to earn at least $75,000 a year.
B. Happiness is impossible to measure, so we will not be able to study happiness in the laboratory.
C. Caffeine is a dangerous drug, so we should all avoid drinking coffee.
D. Blondes have more fun.

Why do we need to understand the concept of “operational definitions?”
A. Without terms like this one there would be no market for books on research methods.
B. Because we cannot have different people being creative in how they design research projects.
C. How else will we know about definitions?
D. So everyone is talking about the same variables and measuring them the same way.

### Sample Active Application Problems

### Interactive Text Problems

Other-Agent (Doug) to Guide-Agent: Why do dogs lick peoples' faces? I think I will test that hypothesis for my science project. What do you think?
Guide-Agent to Doug: Why don't we ask our friend?
Guide-Agent to User: Tell me what you think about Doug's hypothesis?
Ideal Answers—The expectations below provide the answers that ARIES will be looking for and eliciting through hints and prompts:
   Expectation: “Why do dogs lick peoples' faces?” is a question and not a hypothesis.
   Expectation: Hypotheses are assertions or claims that specify a relation between two or more variables.
If the user responds: “Sounds “It is an interesting question, but think about like a good science project to the definition of a hypothesis. Try again.” me,” Doug might reply with the hint:
If the user types: “Ok, a “So, I'm wondering whether my question is a hypothesis is an assertion or hypothesis.” claim that specifies a relationship.” Doug might reply:

The student should now realize that a question is not a hypothesis and will provide the correct answer or, if necessary, he will be led to review the definition for a hypothesis before responding another time. (A dog might appear and lick Doug's face to show approval of the correct answer.)

### First Evaluation Problem Example

Other-Agent (Donatella) to Guide-Agent: “No more textbooks. Hello money. I just read this thing about an experiment where they showed that students get the same grades regardless of whether they read the textbook.”
Guide-Agent to Donatella: “I think we should have our friend evaluate the study.”
Guide-Agent to User: “Read the article about textbooks to see if Donatella is right. Please type in any problems with the study described in the article or with its interpretation. If you agree with Donatella, then type ‘correct response’”
Presented in Materials box, and Our worst fears have come true, especially for formatted as a magazine article: those who are paying top dollar for textbooks used by college and university students. A study done at a large university suggests that students do not learn from their textbooks. In the fall semester of last year, all of the students in a statistics course were told that the textbook was optional and that all important information would be given in hand-outs. In the following spring semester, all students in the same statistics course were told that the textbook was required, but all important information would be given in hand-outs. The same professor taught the two statistics courses and gave the same lectures to each. The researcher, Dr. Ralph Meany, found no difference on the final exam scores between the two classes. When reached for comment, Meany said, “Why should students be placed under undue financial burden if they are not learning from their textbooks, as this study clearly indicates.”
Ideal Answers:
   Expectation: students may not have read the textbook even if it was required
   Expectation: student differences between the conditions could bias the results
   Expectation: students were not randomly assigned to condition
   Expectation: results may not generalize to other classes where they are not given handouts

### Second Evaluation Problem Example

Other-Agent to Guide-Agent: I just heard about a study that proves that molasses causes yeast cells to produce carbon dioxide. The experiment essentially shows that the yeast cells produce more carbon dioxide, the more molasses they are fed.
In materials box: A researcher from Podunk University recently demonstrated a direct relationship between the amount of molasses fed to yeast cells and the amount of carbon dioxide that these cells produce. Five test tubes were filled with 20 ml of a solution containing varying concentrations of molasses and water. One tube contained only molasses; the others were filled with combinations of water and molasses. Yeast cells were added. The next day, the researcher recorded the amount of gas produced in each tube. As can be seen clearly in the Figure on the right (not depicted), higher concentrations of molasses yielded more carbon dioxide gas.
Guide-Agent to Student: Is this conclusive? Can you think of some flaws in the experiment?

### Ideal Answers:

Expectation: The researcher needed to include a control tube that contains no molasses.
Expectation: The researcher needs to replicate the results before the finding can be called
conclusive.

### Ask Problem

Guide-Agent to student: Pretend that you are in charge of a retirement home. You are always interested in improving the health benefits of your residents. You see the ad below and wonder whether you should buy their water. In fact, you want to buy bottled water for the home anyway. To my left is Dr. Johnson who works at the Rama Water Company and has some knowledge of the study mentioned in the ad. Ask him questions so that you can decide whether you should buy their water. When you have decided, type “finished.”
In Materials box (formatted as Looking to improve your arthritis? The Rama an advertisement): Water Company has perfected a treatment called Rama Spectroscopy that they say improves cell hydration. The results of a scientific study show that our water had significantly reduced arthritis. To order, call 1-800-RAMAWTR today!

### Diagnostic Questions

Expectation: What was the design of the study?
Answer given by Dr. Johnson: Subjects were measured for arthritis before and after drinking rama water for a month.
Expectation: Was there a control group?
Answer given by Dr. Johnson: All subjects were given rama water to drink.

### Non-Diagnostic Questions

Expectation: Was the dependent variable valid?
Answer given by Dr. Johnson: The dependent variable was X-rays and scores on a questionnaire asking about their arthritis. These are considered valid.
Expectation: What were the results or findings from the study?
Answer given by Dr. Johnson: The X-rays and scores showed significant improvement in arthritis after drinking the water for a month.

### Final Feedback to Student:

If student says ‘yes’ to purchase the water: “It turns out that the study was flawed because there was no control group. Drinking any type of water had appeared to decrease arthritis in that study or there was something else causing the decrease. Unfortunately, the added expensive of buying the water, and the fact that it does not help people at your retirement home, causes you to be demoted.”
If student says ‘no’ to purchase the water: “Good decision. It turns out that the study was flawed because there was no control group. Drinking any type of water had appeared to decrease arthritis or there was something else causing the decrease.”

### Reflection Problem

Guide-Agent to student: Let's suppose that you got a great job after college. You get to return to your own high school as the principal! This is so cool. You always wanted to make school more fun, but now that you are the principal you also have to be sure that students are learning. Happily you found a way to do both. You read the study below [in materials box] that showed that listening to music is important for brain development. The study showed that students who attended at least one concert do better in school than those who never attended a concert. Based on these research findings, you thought it would be a good idea to get the school board to provide enough money so that every student could attend at least one concert. All you need to do is convince the members of the school board that paying students to attend a concert is a good use of the money they have for education. You get all dressed up to present your case to the school board and on the way there you start to get very nervous. You want to be prepared for any questions they might ask about your proposal. What questions do you think the members of the school board will ask about the study you read and about your proposal? How would you answer their questions? Write three good questions that you think someone on the school board is likely to ask, and be sure to answer each one. When you have written three questions and answered each one, decide if you should turn around and drive home without asking the school board to pay for every student to attend a concert or whether you should keep driving and make a strong case before the school board. Type “finished” after you answer the question about turning around and going home or continuing on to the meeting of the school board.
In Materials box (formatted as a “The researchers at Snooty University newspaper write-up of a investigated the effects of listening to music research report): on brain development. They asked 6 students at the High School for the Arts in Hollywood if they ever attended a concert. Two students said they went with their parents to hear an opera in the park. Four students said they never went to a concert, but they all agreed that they sure would like to hear Dash Board Confessional or Foo Fighters in concert, if they could afford it. The students who attended a concert had better grades in school than those who never attended a concert. They also looked neater than the students who never attended a concert. The researchers concluded that “It is clear that listening to music is good for high school students. It helps them develop their brain so that they become better students and neater too.”
Final question: Now that you have listed three questions and answered them, will you turn around and drive home without showing up at the board meeting or will you keep driving and go to the board meeting to make your best case for your request?

### Final Feedback to Student:

If student responds “keep “It turns out that the study was flawed driving” to the board meeting, because the students were not assigned at agent will respond: random to the two groups and they were probably different in many ways besides whether or not they ever attended a concert. We cannot conclude that attending a concert developed their brains, caused better grades in school, or made the students neater. Unfortunately, even though you are the principal, the members of the school board were not impressed with your suggestion and thought you do not understand the basics of research, so they decided to change your job: You are now assigned to monitor the bathrooms at school.
If student responds “turn “Good decision. It turns out that the study around and drive home,” agent was flawed because the students were not will respond: randomly assigned to different groups. The students who attended an opera with their parents could have had parents who made them do more homework and dress neater. The school board was so glad that you decided not to ask them to pay for concerts for the students that they decided to give you the money instead as your annual bonus. You can now attend all the concerts you want with the additional income. You can even take students with you, if that is something you want to do.
   Sample Problem, Abbreviated Curriculum Script, and Real Student Dialog from Critical Thinking Tutor
Tutor-agent (Joe) to Guide-Agent (Crystal): Hey Crystal, remember when I told you that my little sister has autism? I recently read about facilitated communication, a procedure some say improves autistic children's communicating through writing. Facilitated communication is where a person provides minimal help by touching or gently holding a person's hand as they write. They say that the child responds to the physical contact. In the study that I read, autistic children were randomly assigned either to an experimental group or to a control group. In the experimental group, experimenters who were trained in this procedure slightly held the hands of autistic children as they wrote. In the control group, the same experimenters merely sat near the children as they wrote. There were thirty children in each group. The result was that children in the experimental group wrote more complete and complex sentences than children in the control group. Therefore, it was concluded that facilitated communication improves the written communication of autistic children. So, I plan to pay the extra amount of money so that my sister gets this treatment.
Crystal to Joe: Hmm. I do not know if I would support the new procedure based on this study alone. How about we ask someone else?
Crystal to student: Please describe and explain to me problems with the experiment findings, or interpretation. If there are no problems, type good experiment.

### (Abbreviated)

Expectation 1: The experimenters may have guided the hands of the children in the experimental group.

Expectation 2: Experimenter bias may have contaminated the results.

Hints for expectation 1:
What could experimenters do differently in the experimental group as compared to the control group?
What might have the experimenters done when the children wrote in the experimental group?

Prompts for Expectation 1:
In what group were the experimenters touching the children's hand?
Who sat by the children in the groups?
The experimenters who were touching the kid's hands may have attempted to do what with the children's hands?
The facilitated communication requires an experimenter to touch the child's what while writing?

Hints for Expectation 2:
What can you say about the influence experimenters may have had on the results?
What is it called when an experimenter treats participants in the two conditions differently?
If an experimenter is not blind to the condition assignment, what problem might this cause?

Prompts for Expectation 2:
What is it called when an experimenter favors a particular outcome in an experiment?
When an experimenter's behavior favors a particular outcome, it might do what to results?
A study with experimenter bias may have inconclusive what once the data is analyzed?

Summary: Facilitated communication might help autistic children communicate, but we do not know that from the experiment. Because the experimenters knew the hypothesis, they might have been guiding the hands of the children in the experimental group. In essence, experimenters might have written the more complete and complex sentences and not children. This is an example of experimenter bias, when experimenters affect the results of the study.

Example questions that students might ask and the tutor's response:
Student: Were all the children autistic?
Tutor: Yes, all the children were autistic.
Student: Are they able to read and write in general?
Tutor: Yes, all of the children have the same ability in reading and writing.

Sample dialog using this problem and curriculum script:
Student: good experiment
Tutor: No. Um, I bet you can explain this a little bit more.
Student: I think that the children in the experimental group is being helped more than the children in the control group.
Tutor: I think you've covered something important here. The experimenters may have guided the hands of the children in the experimental group. ok . . . Let me help you a little, what can you say about the influence experimenters may have had on the results?
Student: They could have told the children what to write or they wrote the sentences for them.
Tutor: um hum, I am sure you can get this. What is it called when an experimenter favors a particular outcome in an experiment?
Student: favoritism
Tutor: No. It is called experimenter bias. Let's try this together. What is it called when an experimenter treats participants in the two conditions differently?
Student: experimenter bias
Tutor: Alright. It is significant that experimenter bias might have contaminated the results. So, to review facilitated communication might help autistic children communicate, but we do not know that from the experiment. Because the experimenters knew the hypothesis, they might have been guiding the hands of the children in the experimental group. In essence, experimenters might have written the more complete and complex sentences and not children. This is an example of experimenter bias, when experimenters affect the results of the study.

1. A method for teaching a topic to a user, the method comprising:
administering one or more question to assess the user's knowledge of the topic;
displaying a first interactive pedagogical agent and a second interactive pedagogical agent; and
facilitating a trialog between the user, the first interactive pedagogical agent, and the second interactive pedagogical agent;
thereby teaching the topic to the user.

2. The method of claim 1, wherein, if the user has a low level of knowledge of the topic, the step of facilitating a trialog includes presenting a lesson from the first interactive pedagogical agent to the second interactive pedagogical agent while the user observes the lesson.

3. The method of claim 1, wherein, if the user has a medium level of knowledge of the topic, the step of facilitating a trialog includes presenting a lesson from the first interactive pedagogical agent to the user while the second interactive pedagogical agent observes the lesson.

4. The method of claim 1, wherein, if the user has a high level of knowledge of the topic, the step of facilitating a trialog includes asking the user to present a lesson to the second interactive pedagogical agent while the first interactive pedagogical agent observes the lesson.

5. The method of claim 1, wherein the first pedagogical agent is a human.

6. The method of claim 1, wherein the first pedagogical agent is a computer-implemented character.

7. The method of claim 1, wherein the second pedagogical agent is a human.

8. The method of claim 1, wherein the second pedagogical agent is a computer-implemented character.

9. The method of claim 1, wherein the method is implemented in a game environment.

10. The method of claim 1, wherein the method is a computer-implemented method.

11. A computer program product comprising computer-usable medium having control logic stored therein for causing a computer to implement method for teaching a topic to a user, the control logic comprising:
first computer-readable program code means for administering one or more question to assess the user's knowledge of the topic;
second computer-readable program code means for displaying a first interactive pedagogical agent and a second interactive pedagogical agent; and
third computer-readable program code means for facilitating a trialog between the user, the first interactive pedagogical agent, and the second interactive pedagogical agent.

12. The computer-program product of claim 11, wherein, if the user has a low level of knowledge of the topic, the third computer-readable medium presents a lesson from the first interactive pedagogical agent to the second interactive pedagogical agent while the user observes the lesson.

13. The computer-program product of claim 11, wherein, if the user has a medium level of knowledge of the topic, the third computer-readable medium presents a lesson from the first interactive pedagogical agent to the user while the second interactive pedagogical agent observes the lesson.

14. The computer-program product of claim 11, wherein, if the user has a high level of knowledge of the topic, the third computer-readable medium asks the user to present a lesson to the second interactive pedagogical agent while the first interactive pedagogical agent observes the lesson.

15. The computer-program product of claim 11, wherein the first pedagogical agent is a human.

16. The computer-program product of claim 11, wherein the first pedagogical agent is a computer-implemented character.

17. The computer-program product of claim 11, wherein the second pedagogical agent is a human.

18. The computer-program product of claim 11, wherein the second pedagogical agent is a computer-implemented character.

19. The computer-program product of claim 11, wherein the method is implemented in a game environment.

20. The computer-program product of claim 11, wherein the computer-usable medium is non-transitory and tangible.
